(19) United States
(12) Patent Application Publication
(10) Pub. No.: US 2020/0379299 A1
(43) Pub. Date: Dec. 3, 2020

(54) SUBSTRATE, RESIN COMPOSITION FOR PREVENTING LIGHT DIFFUSION, AND IMAGE DISPLAY DEVICE

(71) Applicant: Toray Industries, Inc., Tokyo (JP)

(72) Inventors: Toshiyasu Hibino, Otsu-shi, Shiga (JP); Mika Koshino, Otsu-shi, Shiga (JP); Masao Kamogawa, Otsu-shi, Shiga (JP); Mitsuhito Suwa, Otsu-shi, Shiga (JP)

(73) Assignee: Toray Industries, Inc., Tokyo (JP)

(21) Appl. No.: 16/767,841

(22) PCT Filed: Nov. 27, 2018
(86) PCT No.: PCT/JP2018/043482

§ 371 Date: May 28, 2020

(30) Foreign Application Priority Data
Dec. 4, 2017 (JP) 2017-232355
Jun. 14, 2018 (JP) 2018-113520
Jul. 5, 2018 (JP) 2018-128004

(51) Int. Cl. G02F 1/13357; G02F 1/1335; G02B 1/04; C09D 183/04; C09D 135/02; C09D 7/41; C09D 7/61; C09D 7/40; C09D 5/22

(52) U.S. Cl. CPC G02F 1/133617; G02F 1/133514; G02B 1/04; C09D 183/04; C09D 135/02; G02F 1/1368; C09D 7/61; C09D 7/67; C09D 5/22; G02F 2001/133614; C09D 7/41

(57) ABSTRACT

Provided is a substrate whereby diffusion of light toward a backlight can be suppressed and luminance of an image display device can be enhanced. A substrate having, on a transparent substrate, (a) a color conversion light-emitting layer and (b) a light diffusion prevention layer in this order from the transparent substrate side, the refractive index of the light diffusion prevention layer with respect to a wavelength of 550 nm being 1.20-1.35.

### CROSS REFERENCE TO RELATED APPLICATIONS

This is the U.S. National Phase application of PCT/JP2018/043482, filed Nov. 27, 2018, which claims priority to Japanese Patent Application No. 2017-232355, filed Dec. 4, 2017, Japanese Patent Application No. 2018-113520, filed Jun. 14, 2018, and Japanese Patent Application No. 2018-128004, filed Jul. 5, 2018, the disclosures of each of these applications being incorporated herein by reference in their entireties for all purposes.

### FIELD OF THE INVENTION

The present invention relates to a substrate having a color conversion light emitting layer and a light diffusion preventing layer disposed on a transparent base, an image display device produced thereof, and a light diffusion preventing resin composition.

### BACKGROUND OF THE INVENTION

A liquid crystal display device, which is a type of image display device, generally performs color display by using a white light source such as LED and a color filter that selectively passes red, green, or blue light. A conventional method of manufacturing a color filter that has been generally adopted is to prepare a composition containing a powdery pigment dispersed in a transparent resin such as acrylic resin, spread it on a transparent base such as glass, dry it, and pattern it using a photosensitivity based technique to produce red pixels, green pixels, and blue pixels on the transparent base. However, color display using such a color filter is low in light use efficiency and disadvantageous in terms of color reproducibility.

As a solution, color display devices having high light use efficiency have been proposed including, for example, a color display device having a wavelength conversion unit formed of a wavelength conversion phosphor, a polarization separation unit, and a polarization conversion unit (see, for example, Patent document 1). Another example is a liquid crystal display device that has a blue light source, a liquid crystal element, a color filter containing a phosphor that emits red fluorescence when excited by blue light and a phosphor that emits green fluorescence when excited by blue light, and a light scattering film for scattering blue light (see, for example, Patent document 2).

### PRIOR ART DOCUMENTS

### Patent Documents

Patent document 1: Japanese Unexamined Patent Publication (Kokai) No. 2000-131683

Patent document 2: Japanese Unexamined Patent Publication (Kokai) No. 2009-244383

### SUMMARY OF THE INVENTION

However, the color filters including color conversion phosphors such as those described in Patent documents 1 and 2 emit fluorescence in all directions and suffer a loss of light that are scattered towards the backlight unit, leading to the problem of decreased luminance. In particular, high definition liquid crystal display devices called 4K or 8K units suffer from a serious problem due to a decrease in luminance because of the small pixel size. Thus, an object of the present invention is to provide a substrate capable of suppressing the diffusion of light towards the backlight unit and improving the luminance of image display devices.

The present invention in exemplary embodiments provides a substrate including a transparent base in combination with a color conversion light emitting layer, referred to as (a), and a light diffusion preventing layer, referred to as (b), disposed in this order on the transparent base, the light diffusion preventing layer (b) containing polysiloxane and chain silica particles, and the content of the polysiloxane and the content of the chain silica particles in the light diffusion preventing layer (b) being 4 to 32 wt % and 68 to 96 wt %, respectively.

The present invention in exemplary embodiments also provides a substrate including a transparent base in combination with a color conversion light emitting layer, referred to as (a), and a light diffusion preventing layer, referred to as (b), disposed in this order on the transparent base, the light diffusion preventing layer (b) having a refractive index at a wavelength of 550 nm in the range of 1.20 to 1.35, the light diffusion preventing layer (b) containing polysiloxane and silica particles free of hollow structures, and the content of polysiloxane and the content of the silica particles free of hollow structures in the light diffusion preventing layer (b) being 4 to 32 wt % and 68 to 96 wt %, respectively.

The substrate according to the present invention is designed so that the diffusion of light towards the backlight unit are suppressed to improve the luminance of image display devices.

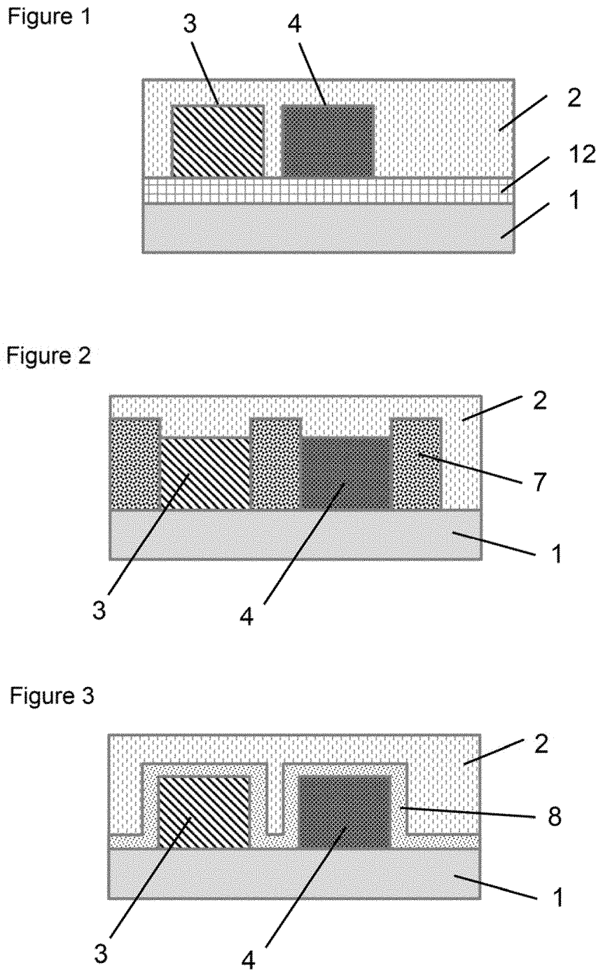

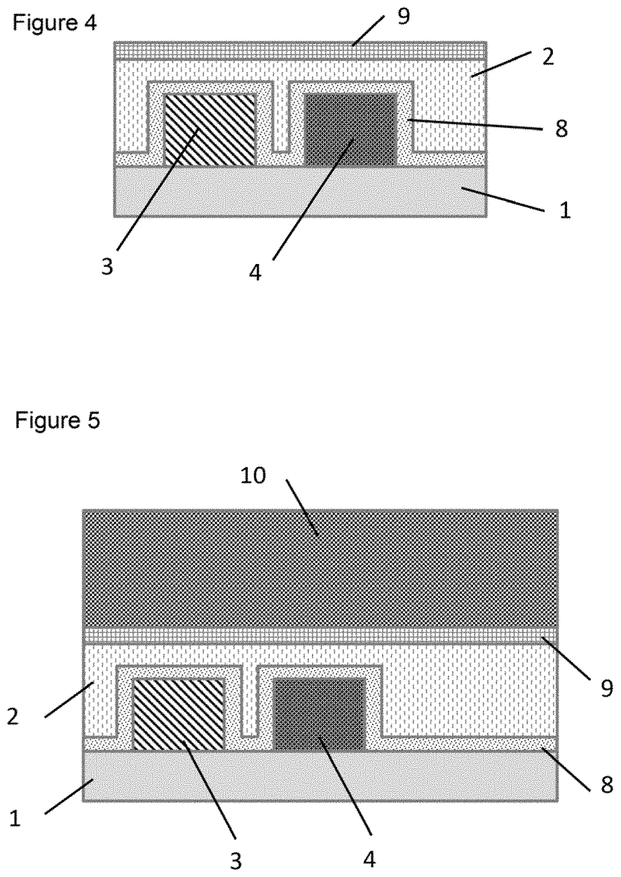

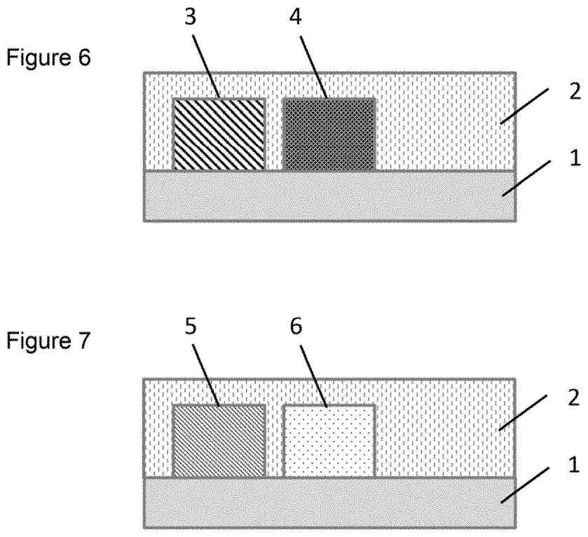

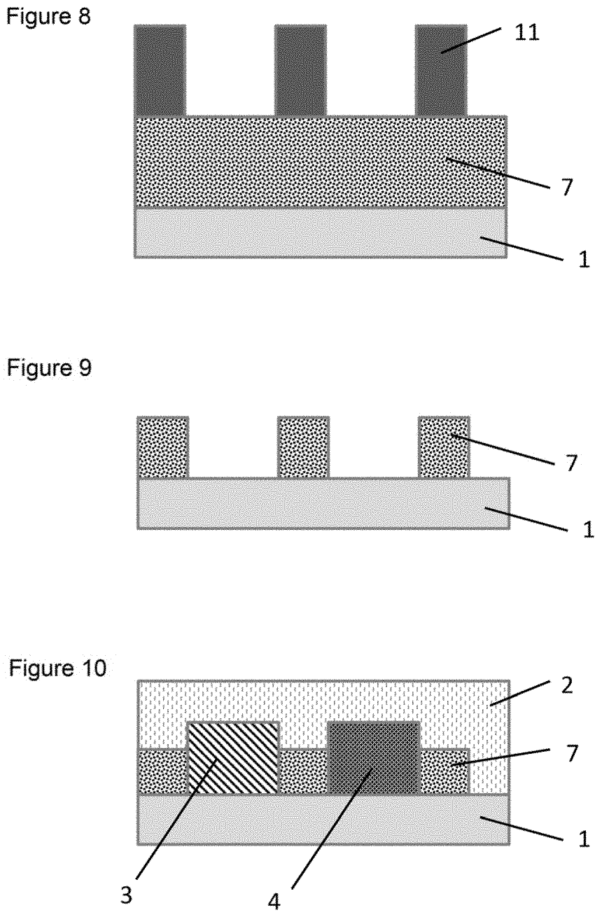

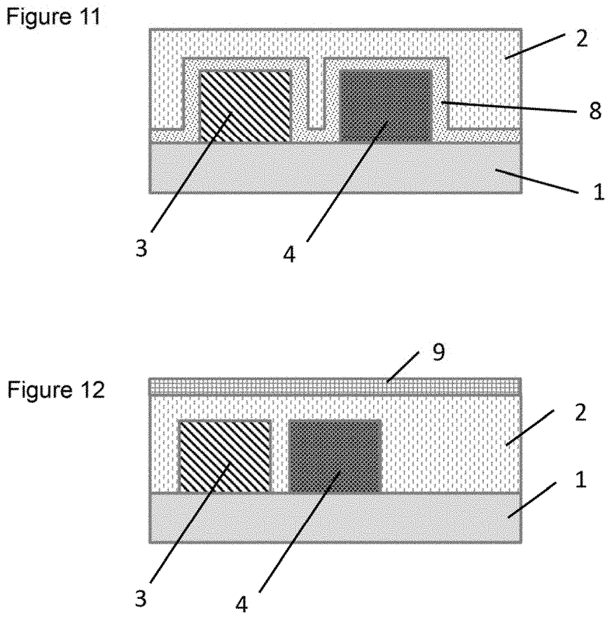

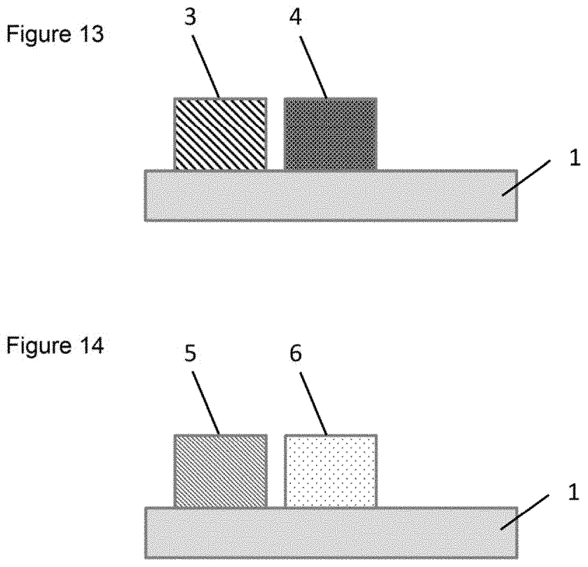

### BRIEF DESCRIPTION OF THE DRAWINGS

[FIG. 1] A schematic diagram of a substrate according to an embodiment of the present invention.

[FIG. 2] A schematic diagram of a substrate according to another embodiment of the present invention.

[FIG. 3] A schematic diagram of a substrate according to still another embodiment of the present invention.

[FIG. 4] A schematic diagram of a substrate according to still another embodiment of the present invention.

[FIG. 5] A schematic diagram of an image display device according to an embodiment of the present invention.

[FIG. 6] A schematic diagram of the substrate prepared in Example 1.

[FIG. 7] A schematic diagram of the substrate prepared in Example 2.

[FIG. 8] A schematic diagram of the resist pattern prepared in Example 7.

[FIG. 9] A schematic diagram of the division wall of silicon nitride prepared in Example 7.

[FIG. 10] A schematic diagram of the substrate prepared in Example 7.

[FIG. 11] A schematic diagram of the substrate prepared in Example 8.

[FIG. 12] A schematic diagram of the substrate prepared in Example 10.

[FIG. 13] A schematic diagram of the substrate prepared in Comparative example 1.

[FIG. 14] A schematic diagram of the substrate prepared in Comparative example 2.

### DETAILED DESCRIPTION OF EMBODIMENTS OF THE INVENTION

The substrate according to an embodiment of the present invention includes a transparent base in combination with a color conversion light emitting layer, referred to as (a), and a light diffusion preventing layer, referred to as (b), disposed in this order on the transparent base. The transparent base functions as a support in the substrate and functions for transmitting light emitted from the color conversion light emitting layer (a). In an image display device, it functions as a protective layer.

The color conversion light emitting layer (a) emits high-luminance light of a specific color, functions as a color filter and as a pixel, and also functions for improving the luminance of the image display device.

The light diffusion preventing layer (b) functions for total reflection of light at the interface with the color conversion light emitting layer (a) and suppressing the diffusion of light and loss of light towards the backlight unit, thereby improving the luminance of the image display device.

The transparent base according to an embodiment of the present invention is one having a light transmittance of 90% or more at wavelengths of 400 nm, 550 nm, 633 nm, and 800 nm. For the light transmittance used for the present invention, the above four wavelengths were adopted as representative wavelengths of light in the visible region because a base sheet is expected to be sufficiently high in light transmittance to ensure high transparency at any wavelength in the visible region if its light transmittance is 90% or more at wavelengths of 400 nm, 550 nm, 633 nm, and 800 nm in the visible region that ranges from 400 to 800 nm. Here, the light transmittance of a transparent base can be measured using an ultraviolet-visible spectrophotometer (UV-260 (trade name), manufactured by Shimadzu Corporation).

Examples of the transparent base include glass plate, resin plate, and resin film Preferred materials of glass plate include alkali-free glass. Preferred materials of resin plate and resin film include polyester resin, acrylic resin, polyimide resin, and polyethersulfone resin. The thickness of the glass plate and the resin plate is preferably 1 mm or less and more preferably 0.6 mm or less. The thickness of the resin film is preferably 100 μm or less.

The transparent base may have a refractive index adjusting layer disposed thereon. The refractive index adjusting layer can increase the efficiency in extracting light emitted from the color conversion light emitting layer (a). The refractive index adjusting layer may have a stacked structure of a plurality of layers having different refractive indices. The refractive index adjusting layer is preferably transparent to prevent loss of light.

The refractive index adjustment layer is preferably low in refractive index in order to suppress the reflection of external light coming through the transparent base and efficiently extract light coming from the color conversion light emitting layer. More specifically, the refractive index of the refractive index adjusting layer at a wavelength of 550 nm is preferably 1.10 to 1.50, and more preferably 1.20 to 1.35. The refractive index adjusting layer is preferably formed by applying a resin composition, and may be formed of a resin composition designed for forming a light diffusion preventing layer, which will be described later, in order to serve for adjusting the refractive index in the above range.

FIG. 1 shows a substrate having a refractive index adjusting layer according to an embodiment of the present invention. A glass transparent base 1 has a refractive index adjusting layer 12 disposed thereon, and further has a color conversion light emitting layer 3 containing red quantum dots and a color conversion light emitting layer 4 containing green quantum dots disposed thereon.

The transparent base may have a protective layer disposed thereon. The protective layer can protect the color conversion light emitting layer (a) from moisture and oxygen. The protective layer is preferably a film produced by the CVD method. CVD is a method that uses a general purpose CVD apparatus to cause a reaction of raw material gases of the target film in a vacuum and deposit the components of the film on the transparent base. When SiO₂ is to be formed, SiH₄ or SiCl₄ are reacted with O₂ in a vacuum and deposited on a transparent base to form a CVD film of SiO₂. When SiN is to be formed, SiH₄ or SiH₂Cl₂ and ammonia gas may be used to form a CVD film of SiN. If necessary, the temperature in the chamber in the apparatus is increased to accelerate the reaction, thereby forming a dense film

It is preferable that the color conversion light emitting layer (a) contains an inorganic phosphor and/or an organic phosphor. For example, when combined with a backlight that emits blue light, it is preferable that a region corresponding to a red pixel contains a phosphor for red color that is excited by blue exciting light to emit red fluorescence, that a region corresponding to a green pixel contains a phosphor for green color that is excited by blue exciting light to emit green fluorescence, and that a region corresponding to a blue pixel does not contain a phosphor.

Examples of the inorganic phosphor include those excited by exciting light having a wavelength of 400 to 500 nm and giving a peak in the region of 500 to 700 nm in the emission spectrum and inorganic semiconductor fine particles called quantum dots. Typical shapes of such inorganic phosphors include sphere and column.

An inorganic phosphor can emit lights of various colors such as green and red depending on the peak wavelength in the emission spectrum.

Examples of such inorganic phosphors include YAG based phosphors, TAG based phosphors, sialon based phosphors, Mn⁴⁺ activated fluoride complex phosphors, and inorganic semiconductors called quantum dots. Two or more of these may be used in combination. Of these, quantum dots are preferred. Quantum dots are smaller in average particle diameter than other phosphors and serve more effectively for smoothing the surface of the color conversion light emitting layer (a) to suppress light scattering on the surface, thereby realizing a higher efficiency in extracting light.

Good materials for quantum dots include, for example, semiconductors of Group II-IV, Group III-V, Group IV-VI, and Group IV. Such inorganic semiconductors include, for example, Si, Ge, Sn, Se, Te, B, C (including diamond), P, BN, BP, BAs, AIN, AlP, AlAs, AlSb, GaN, GaP, GaAs, GaSb, InN, InP, InAs, InSb, ZnO, ZnS, ZnSe, ZnTe, CdS, CdSe, CdSeZn, CdTe, HgS, HgSe, HgTe, BeS, BeSe, BeTe, MgS, MgSe, GeS, GeSe, GeTe, SnS, SnSe, SnTe, PbO, PbS, PbSe, PbTe, CuF, CuCl, CuBr, CuI, Si₃N₄, Ge₃N₄, and Al₂O₃. Two or more of these may be used in combination.

The quantum dots may contain a p-type dopant or an n-type dopant. The quantum dots may have a core-shell structure. In such a core-shell structure, the shell may be covered with an appropriate suitable functional layer (or plurality of such layers) to suit particular purposes, or the shell surface may be surface-treated and/or chemically modified.

Typical shapes of the quantum dots include sphere, column shape, scale, plate, and indeterminate forms. The quantum dots may have any appropriately selected average particle diameters depending on desired emission wavelengths, but it is preferable that their diameters are 1 to 30 nm. The use of quantum dots having an average particle diameter of 1 to 10 nm serves to give a sharp peak in the emission spectrum of blue, green, and red lights. For example, blue light is emitted when the average particle diameter of the quantum dots is about 2 nm, green light is emitted when the average particle diameter is about 3 nm, and red light is emitted when the average particle diameter is about 6 nm. It is preferable for quantum dots to have an average particle diameter of 2 nm or more, more preferably 8 nm or less. The average particle diameter of quantum dots can be measured by the dynamic light scattering method. Good devices for measuring the average particle diameter include dynamic light scattering photometer DLS-8000 (manufactured by Otsuka Electronics Co., Ltd.).

If containing quantum dots, the color conversion light emitting layer (a) preferably has a thickness of about 1 to 10 μm.

Examples of the organic phosphor include pyrromethene derivatives having basic skeletons as represented by the following structural formula (7) to work as phosphors that emit red fluorescence when excited by blue exciting light, and pyrromethene derivatives having basic skeletons as represented by the following structural formula (8) to work as phosphors that emit green fluorescence when excited by blue exciting light. Other examples include perylene derivatives, porphyrin derivatives, oxazine derivatives, and pyrazine derivatives which emit red or green fluorescence depending on the substituent selected. Two or more of these may be contained together. Of these, pyrromethene derivatives are preferred because of their high quantum yields. Pyrromethene derivatives can be produced by, for example, the method described in Japanese Unexamined Patent Publication (Kokai) No. 2011-241160.

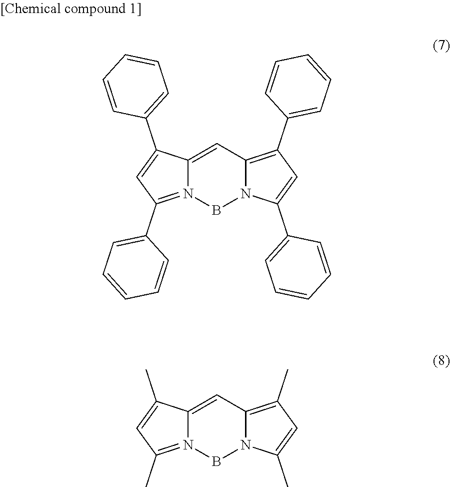

Since these organic phosphors are soluble in solvents, a color conversion light emitting layer (a) having a desired thickness can be easily formed.

The thickness of the color conversion light emitting layer (a) is preferably 0.5 μm or more, and more preferably 1 μm or more, from the viewpoint of obtaining an image display device having improved color characteristics. From the viewpoint of obtaining an image display device having a decreased thickness and higher curved surface workability, on the other hand, the thickness is preferably 30 μm or less, and more preferably 20 μm or less.

The size of each pixel in the color conversion light emitting layer (a) is generally about 20 to 200 μm.

In the color conversion light emitting layer (a), it is preferable that phosphor-containing pixels are disposed so that they are separated from each other by division walls. The existence of a division wall between pixels serves to suppress the diffusion and color mixing of emitted light more effectively.

FIG. 2 shows a substrate having division walls according to an embodiment of the present invention. A glass transparent base 1 has a color conversion light emitting layer 3 containing red quantum dots and a color conversion light emitting layer 4 containing green quantum dots, which are separated by a division wall 7, and also has a light diffusion preventing layer 2.

The division wall preferably contains a black material such as carbon black and titanium nitride compound, or a high refractive index material such as silicon nitride. Here, a high refractive index means a refractive index at a wavelength of 550 nm of 1.7 or more at 23° C. The incorporation of a black material serves to absorb the leakage light from the color conversion light emitting layer to suppress its interference with the luminescent color. In addition, the incorporation of a high refractive index material serves to suppress the reflection of the emitted light.

For the present invention, the light diffusion preventing layer (b) preferably has a refractive index at a wavelength of 550 nm of 1.20 to 1.35. Setting the refractive index to 1.20 or more serves to suppress the decrease of transmitted light due to reflection of light from the backlight unit on the surface of the light diffusion preventing layer or phosphor, thereby further improving the luminance On the other hand, setting the refractive index to 1.35 or less serves allow the emitted light to be reflected more efficiently by the light diffusion preventing layer (b), thereby further improving the luminance. Note that the refractive index of the light diffusion preventing layer (b) refers to its refractive index at a wavelength of 550 nm at 23° C. and can be measured using a prism coupler (PC-2000, manufactured by Metricon), which is a refractive index measuring device.

In an embodiment of the present invention, the light diffusion preventing layer (b) preferably contains polysiloxane and silica particles free of a hollow structure. In another embodiment of the present invention, the light diffusion preventing layer (b) preferably contains polysiloxane and chain silica particles. The silica particles may be in a chain-like form and free of a hollow structure.

The polysiloxane is highly compatible with inorganic particles such as silica particles and functions as a binder that works to form a transparent layer.

In addition, the incorporation of silica particles free of a hollow structure serves for efficient formation of minute voids in the light diffusion preventing layer (b) to reduce the refractive index, allowing the refractive index to be adjusted easily in the above-mentioned range. In addition, they do not have hollow structures that can cause cracks easily at the time of curing and shrinkage and accordingly, cracking can be suppressed. Here, a silica particle free of a hollow structure refers to a silica particle that is solid in the interior and free of a hollow.

In addition, the incorporation of chain silica particles serves for efficient formation of minute voids in the light diffusion preventing layer (b) to reduce the refractive index, allowing the refractive index to be adjusted easily in the above-mentioned range. Furthermore, since the chain silica particles are deposited to form a cured film, stress can be easily relaxed, and cracks during shrinkage can be suppressed. Here, a chain silica particle refers to an aggregate formed of a plurality of silica particles that are connected in a string.

Note that in the light diffusion preventing layer (b), polysiloxane and silica particles free of hollow structures or chain silica particles (hereinafter collectively referred to sometimes as silica particles) may be disposed independently or may be disposed in a state in which polysiloxane and silica particles are bonded to each other. From the viewpoint of the uniformity of the light diffusion preventing layer (b), it is preferable that the polysiloxane and the silica particles contained are in a bonded state.

It is preferable for the polysiloxane to have a structural unit as represented by one of the general formulae (4) to (6) given below. In that case, the refractive index of the light diffusion preventing layer (b) can be easily adjusted to 1.20 to 1.35.

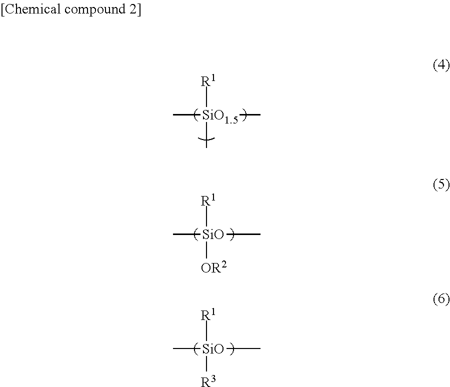

In the above general formulae (4) to (6), R¹ represents an alkyl fluoride group having 1 to 10 carbon atoms; R² represents a monovalent hydrocarbon group having 1 to 3 carbon atoms; and R³ represents an alkyl fluoride group having 1 to 10 carbon atoms or a monovalent hydrocarbon group having 1 to 3 carbon atoms. If a plurality of R¹ to R³ groups are contained, they may be identical to or different from each other.

It is preferable for the polysiloxane to have a structural unit as represented by any of the general formulae (1) to (3) given below. In that case, this can improve its adhesion to the transparent base.

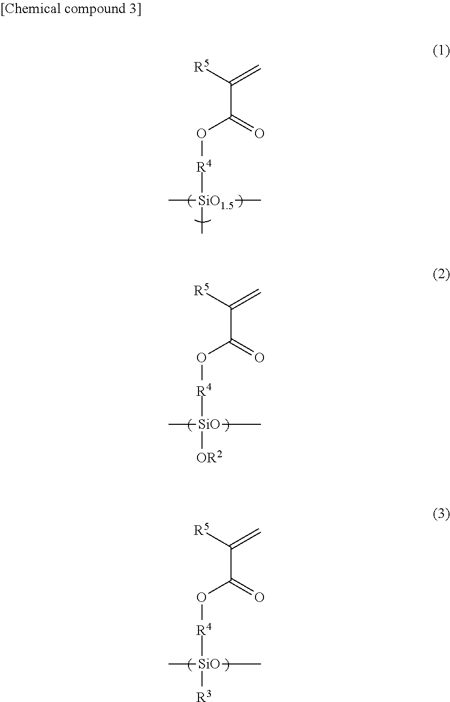

In the above general formulae (1) to (3), R² represents a monovalent hydrocarbon group having 1 to 3 carbon atoms; R³ represents an alkyl fluoride group having 1 to 10 carbon atoms or a monovalent hydrocarbon group having 1 to 3 carbon atoms; R⁴ represents a divalent hydrocarbon group having 1 to 10 carbon atoms; and R⁵ represents a hydrogen atom or a methyl group.

A preferred method for synthesizing a polysiloxane having such a structure is to hydrolyze an organosilane compound having a structure represented by any one of the above general formulae (1) to (6) and, if necessary, another organosilane compound and then perform a condensation polymerization reaction of the hydrolysates in the presence of a solvent. The conditions for the hydrolysis and condensation polymerization reactions may be set up appropriately taking into consideration the reaction scale, the size and shape of the reaction container, etc. For example, a preferred procedure is adding an acid or basic catalyst and water to an organosilane compound in a solvent over a period of 1 to 180 minutes and then subjecting them to a hydrolysis reaction for 1 to 180 minutes at 30° C. to 90° C., followed by condensation polymerization at 100° C. to 150° C. for 1 to 5 hours.

The content of polysiloxane in the light diffusion preventing layer (b) is preferably 4 wt % or more from the viewpoint of suppressing the generation of cracks. On the other hand, the content of polysiloxane is preferably 32 wt % or less from the viewpoint of ensuring thixotropy through network formation among silica particles and maintaining an appropriate air layer in the light diffusion preventing layer (b) to further reduce the refractive index. Its content is more preferably 10 wt % or more and 30 wt % or less.

Examples of the silica particles free of hollow structures include Snowtex (registered trademark) and Organosilica Sol (registered trademark) series (isopropyl alcohol dispersion, ethylene glycol dispersion, methyl ethyl ketone dispersion, dimethyl acetamide dispersion, methyl isobutyl ketone dispersion, propylene glycol monomethyl acetate dispersion, propylene glycol monomethyl ether dispersion, methanol dispersion, ethyl acetate dispersion, butyl acetate dispersion, xylene-n-butanol dispersion, toluene dispersion, etc., having product names of PGM-ST, PMA-ST, IPA-ST, IPA-ST-L, IPA-ST-ZL, IPA-ST-UP, etc.) manufactured by Nissan Chemical Industries, Ltd. Two or more of these may be contained together.

Chain silica particle products include, for example, Organosilica Sol series (isopropyl alcohol dispersion, ethylene glycol dispersion, methyl ethyl ketone dispersion, etc., having product names of IPA-ST-UP, MEK-ST-UP, etc.) manufactured by Nissan Chemical Co., Ltd.

The content of the silica particles free of hollow structures in the light diffusion preventing layer (b) is preferably 68 wt % or more from the viewpoint of ensuring thixotropy developed by the network among silica particles free of hollow structures and maintaining an appropriate air layer in the light diffusion preventing layer (b) to further reduce the refractive index. On the other hand, the content of the silica particles free of hollow structures is preferably 96 wt % or less from the viewpoint of suppressing the generation of cracks. Its content is more preferably 70 wt % or more and 90 wt % or less.

The content of the chain silica particles in the light diffusion preventing layer (b) is preferably 68 wt % or more from the viewpoint of ensuring thixotropy developed by the network among chain silica particles and maintaining an appropriate air layer in the light diffusion preventing layer (b) to further reduce the refractive index. On the other hand, the content of the chain silica particles is preferably 96 wt % or less from the viewpoint of suppressing the generation of cracks.

The thickness of the light diffusion preventing layer (b) is preferably 0.1 μm or more, and more preferably 1 μm or more, from the viewpoint of covering the step of the color conversion light emitting layer (a) to suppress the occurrence of defects. On the other hand, the thickness of the light diffusion preventing layer (b) is preferably 20 μm or less, and more preferably 10 μm or less, from the viewpoint of reducing the stress that can cause cracking in the light diffusion preventing layer (b).

The substrate according to the present invention preferably includes a protective layer I, referred to as (c), between the color conversion light emitting layer (a) and the light diffusion preventing the layer (b). The existence of the protective layer I (c) serves to prevent the resin components in the light diffusion preventing layer (b) from penetrating into the light conversion light emitting layer (a) during the step for forming the light diffusion preventing layer (b), thereby increasing the life of the light conversion light emitting layer (a).

FIG. 3 shows a typical substrate having a protective layer I (c) according to an embodiment of the present invention. A glass transparent base 1 has a color conversion light emitting layer 3 containing red quantum dots and a color conversion light emitting layer 4 containing green quantum dots and also has a protective layer I 8 and a light diffusion preventing layer 2 that cover them.

The protective layer I (c) is preferably in the form of an inorganic film, and more preferably a film of silicon nitride and/or silicon oxide which are high in barrier property. The protective layer I (c) preferably has a thickness of 50 to 1,000 μm. Although phosphors tend to be deteriorated due to permeation of moisture from the outside, the degradation of the light conversion light emitting layer (a) can be suppressed by setting the thickness of the protective layer I (c) to 50 nm or more. On the other hand, the thickness of the protective layer I (c) is preferably 1,000 nm or less from the viewpoint of reducing the distance between the light conversion light emitting layer (a) and the light diffusion preventing layer (b) in order to more efficiently realize the effect of the light diffusion preventing layer (b).

The substrate according to the present invention preferably includes a protective layer II, referred to as (d), on the light diffusion preventing layer (b). The existence of the protective layer II (d) serves to suppress the deterioration of the light diffusion preventing layer (b) due to moisture penetration to increase the life of the light conversion light emitting layer (a).

FIG. 4 shows a typical substrate having a protective layer II (d) according to an embodiment of the present invention. A glass transparent substrate 1 has a color conversion light emitting layer 3 containing red quantum dots and a color conversion light emitting layer 4 containing green quantum dots and also has a protective layer I 8 and a light diffusion preventing layer 2 that cover them. It further has a protective layer II 9 on the light diffusion preventing the layer 2.

The protective layer II (d) is preferably in the form of an inorganic film, and more preferably a film of silicon nitride and/or silicon oxide which are high in barrier property. The protective layer II (d) preferably has a thickness of 50 to 1,000 μm. Although phosphors tend to be deteriorated due to permeation of moisture from the outside, the degradation of the light conversion light emitting layer (a) can be suppressed by setting the thickness of the protective layer II (d) to 50 nm or more. On the other hand, the thickness of the protective layer II (d) is preferably 1,000 nm or less from the viewpoint of reducing the distance between the light conversion light emitting layer (a) and the backlight unit in order to decrease the light diffusion loss. A method for producing the substrate according to an embodiment of the present invention is described below. It is preferable to form a color conversion light emitting layer (a), a protective layer I (c) (if necessary), a light diffusion preventing layer (b), a protective layer II (d) (if necessary), and a refractive index adjusting layer on a transparent base.

It is preferable that the formation of the color conversion light emitting layer (a) is performed by using a resin composition for color conversion light emitting layer formation to be used to constitute the color conversion light emitting layer (a). It is preferable to spread the resin composition for color conversion light emitting layer formation and then subjected to it to preliminary heating. Examples of the method for spreading the resin composition for color conversion light emitting layer formation include the slit coating method and the spin coating method. Good devices for the preliminary heating include hot air oven. The preliminary heating temperature is preferably 80° C. to 120° C., and the preliminary heating time is preferably 5 to 15 minutes. It is preferable that a pattern is formed subsequently by exposure through a photomask and development. Good developers include an aqueous solution of tetramethylammonium hydroxide. Rinsing with pure water is preferably performed after the development step. It is preferable to form a color conversion light emitting layer (a) by heating the patterned transparent base. Good devices for the heating include hot air oven. The heating temperature is preferably 120° C. to 200° C., and the heating time is preferably 15 to 60 minute. In the case of forming a color conversion light emitting layer (a) having a plurality of colors, the above step is repeated using a resin composition for color conversion light emitting layer formation of each color.

It is preferable that the protective layer I (c) is formed by CVD.

It is preferable that the light diffusion preventing layer (b) is formed by spreading a resin composition for light diffusion prevention, which will be described later, over the transparent base provided with the color conversion light emitting layer (a), followed by prebaking and curing. Good methods for spreading a resin composition for light diffusion prevention include the spin coating method, roll coating printing method, spray printing method, and slit coating method. When the slit coating method is used, for example, the slit nozzle may be divided into a plurality of nozzles to discharge the composition along a plurality of lines to form a striped pattern.

Good heating apparatuses used for prebaking include, for example, hot plate and oven. The prebaking may be performed under any appropriate conditions such as in a nitrogen atmosphere, oxygen atmosphere, a nitrogen/oxygen atmosphere, and air atmosphere. The prebaking temperature is preferably 50° C. to 150° C., and the prebaking time is preferably 30 seconds to 30 hours. The thickness of the prebaked film is preferably 0.05 to 10 μm.

Good heating apparatuses used for curing include, for example, hot plate and oven. The curing may be performed under any appropriate conditions such as in a nitrogen atmosphere, oxygen atmosphere, a nitrogen/oxygen atmosphere, and air atmosphere. The curing temperature is preferably 100° C. to 250° C., and the curing time is preferably 15 minutes to 2 hours.

The resin composition for light diffusion prevention preferably contains the aforementioned polysiloxane, the aforementioned silica particles free of hollow structures, and a solvent. In addition, the aforementioned chain silica may be contained instead of the silica free of hollow structures, or the chain silica may be contained together with the silica free of hollow structures. The solvent may be the same solvent as used for hydrolysis or condensation polymerization reaction, or may be another solvent. Two or more of solvents may be contained together. In addition, various additives such as silane coupling agent, crosslinking agent, sensitizer, thermal radical generator, dissolution promoter, dissolution inhibitor, surfactant, thickener, stabilizer, antifoaming agent, and metal compound particles other than silica particles may be contained unless they impair the effect of the present invention.

The content of polysiloxane in the resin composition for light diffusion prevention is preferably 4 to 32 wt % of the solid content. The content of the silica particles free of hollow structures in the resin composition for light diffusion prevention is preferably 68 to 96 wt % of the solid content.

It is preferable that the protective layer II (d) is formed by CVD.

The image display device according to an embodiment of the present invention includes the aforementioned substrate, TFT, and backlight unit. The use of a substrate according to the present invention can serve to improve the luminance.

FIG. 5 shows an image display device according to an embodiment of the present invention. It includes a substrate composed of a glass transparent base 1 that supports a color conversion light emitting layer 3 containing red quantum dots, a color conversion light emitting layer 4 containing green quantum dots, a protective layer I 8 that cover them, a light diffusion preventing layer 2, and a protective layer II 9, in combination with a liquid crystal/backlight unit 10.

### EXAMPLES

### <¹H-NMR Measurement>

¹H-NMR measurement of organic phosphors was carried out in a deuterated chloroform solution using a superconducting FT-NMR device (EX-270, manufactured by JEOL Ltd.). ¹H-NMR measurement of polysiloxanes containing silica particles was carried out in a deuterated acetone solution using a superconducting FT-NMR device (EX-270).

### <²⁹Si-NMR Measurement>

²⁹Si-NMR measurement of polysiloxanes containing silica particles was carried out in a deuterated acetone solution using a superconducting FT-NMR device (EX-270).

### <Particle Diameter Measurement>

Lumidot 640 or Lumidot 530, which was used as material for quantum dots, was put in a quartz cell, and the average particle diameter was measured using a dynamic light scattering photometer (DLS-8000, manufactured by Otsuka Electronics Co., Ltd.).

The materials used in Examples and Comparative examples are described below.

### Synthesis Example 1

### Red Organic Phosphor

A mixed solution of 300 mg of 4-(4-t-butylphenyl)-2-(4-methoxyphenyl) pyrrole, 201 mg of 2-methoxybenzoyl chloride, and 10 ml of toluene was heated at 120° C. for 6 hours in a nitrogen gas stream. Evaporation was performed after cooling to room temperature. Washing with 20 ml of ethanol and drying in a vacuum were performed to provide 260 mg of 2-(2-methoxybenzoyl)-3-(4-t-butylphenyl)-5-(4-methoxyphenyl) pyrrole. A mixed solution of 260 mg of 2-(2-methoxybenzoyl)-3-(4-t-butylphenyl)-5- (4-methoxyphenyl) pyrrole, 180 mg of 4-(4-t-butylphenyl)-2-(4-methoxyphenyl) pyrrole, 206 mg of methanesulfonic anhydride, and 10 ml of deaerated toluene was heated at 125° C. for 7 hours in a nitrogen gas stream. After cooling to room temperature, 20 ml of water was added and extraction was performed with 30 ml of dichloromethane. The organic layer was washed twice with 20 ml of water and the water was evaporated to give pyrromethene as a residue after drying in a vacuum. Then, 305 mg of diisopropylethylamine and 670 mg of a boron trifluoride diethyl ether complex were added to a mixed solution of the pyrromethene obtained above and 10 ml of toluene in a nitrogen gas stream, and the mixture was stirred at room temperature for 3 hours. Then, 20 ml of water was added and extraction was performed with 30 ml of dichloromethane. The organic layer was washed twice with 20 ml of water and dried with magnesium sulfate, followed by evaporation. The resulting material was purified by silica gel column chromatography and dried in a vacuum to provide 0.27 g of a red-purple powder (yield 70%). The resulting red-purple powder was subjected to ¹H-NMR analysis and the following results were obtained, showing that the red-purple powder obtained above was a compound as represented by the structural formula given below [R−1].

¹H-NMR (CDCl₃ (d=ppm)): 1.19 (s, 18H), 3.42 (s, 3H), 3.85 (s, 6H), 5.72 (d, 1H), 6.20 (t, 1H), 6.42⁻6.97 (m, 16H), 7.89 (d, 4H).

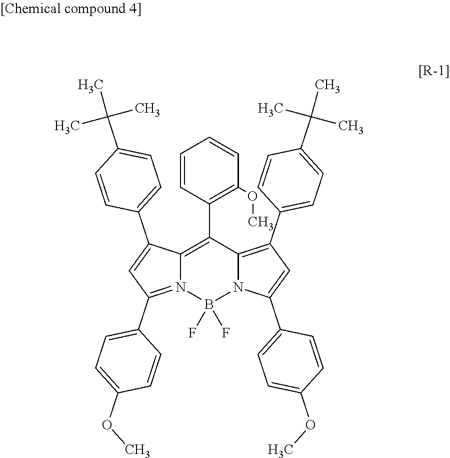

### Synthesis Example 2

### Green Organic Phosphor

A flask containing 3,5-dibromobenzaldehyde (3.0 g), 4-t-butylphenylboronic acid (5.3 g), tetrakis (triphenyl phosphine) palladium (0) (0.4 g), and potassium carbonate (2.0 g) was filled with nitrogen gas. Deaerated toluene (30 mL) and deaerated water (10 mL) were added to this and refluxed for 4 hours. The reaction solution was cooled to room temperature, and the organic layer was separated and washed with saturated brine. The organic layer was dried with magnesium sulfate and filtered, and the solvent was evaporated. The resulting reaction product was purified by silica gel chromatography to give white solid of 3,5-bis(4-t-butylphenyl) benzaldehyde (3.5 g). Then, 3,5-bis(4-t-butylphenyl) benzaldehyde (1.5 g) and 2,4-dimethylpyrrole (0.7 g) were put in a flask, and dehydrated dichloromethane (200 mL) and trifluoroacetic acid (1 drop) were added, followed by stirring for 4 hours in a nitrogen atmosphere. A dehydrated dichloromethane solution of 2,3-dichloro -5,6- dicyano -1,4-benzoquinone (0.85 g) was added and stirred for additional 1 hour. After the completion of the reaction, a boron trifluoride diethyl ether complex (7.0 mL) and diisopropylethylamine (7.0 mL) were added and stirred for 4 hours, and then water (100 mL) was added, followed by stirring and separation of the organic layer. The organic layer was dried with magnesium sulfate and filtered, and the solvent was evaporated. The resulting reaction product was purified by silica gel chromatography to provide 0.4 g of a green powder (yield 17%). The resulting green powder was subjected to ¹H-NMR analysis and the following results were obtained, showing that the green powder obtained above was a compound as represented by the structural formula given below [G−1].

¹H-NMR (CDCl₃ (d ppm)): 7.95 (s, 1H), 7.63-7.48 (m, 10H), 6.00 (s, 2H), 2.58 (s, 6H), 1.50 (s, 6H), 1.37 (s, 18 H).

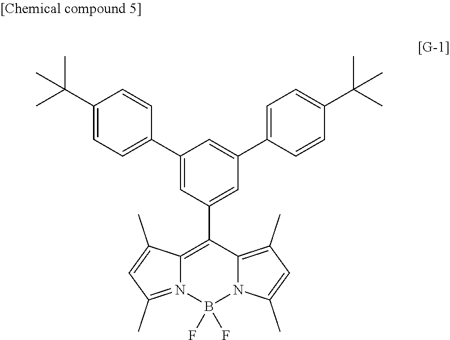

The silica particles prepared in Synthesis examples 3 to 7 below are chain silica particles free of hollow structures.

### Synthesis Example 3

### Silica Particle-Containing Polysiloxane Solution (PS-1)

In a 500 ml three-necked flask, 0.05 g (0.4 mmol) of methyltrimethoxysilane (KBM-13, manufactured by Shin-Etsu Chemical Co., Ltd.), 0.66 g (3.0 mmol) of trifluoropropyltrimethoxysilane (KBM-7103, manufactured by Shin-Etsu Chemical Co., Ltd.), 0.10 g (0.4 mmol) of trimethoxysilylpropylsuccinic anhydride (KBM-967, manufactured by Shin-Etsu Chemical Co., Ltd.), 7.97 g (34 mmol) of γ-acryloxypropyltrimethoxysilane (KBM-5103, manufactured by Shin-Etsu Chemical Co., Ltd.), and 224.37 g of an isopropyl alcohol dispersion containing 15.6 wt % of silica particles (IPA-ST-UP, manufactured by Nissan Chemical Industries, Ltd.) were mixed, followed by adding 163.93 g of ethylene glycol mono-t-butyl ether. While stirring at room temperature, an aqueous phosphoric acid solution prepared by dissolving 0.088 g of phosphoric acid in 4.09 g of water was added over 3 minutes. Subsequently, the flask was immersed in an oil bath at 40° C., followed by stirring for 60 minutes and then heating the oil bath to reach 115° C. over 30 minutes. One hour after the start of heating, the internal temperature in the solution reached 100° C. and heating was continued further while stirring for additional 2 hours (the internal temperature maintained at 100° C. to 110° C.) to provide a silica particle-containing polysiloxane solution (PS-1). Here, nitrogen gas was supplied at a rate of 0.05 L (liter) per minute during the temperature elevation and heating/stirring periods. A total of 194.01 g of methanol and water was distilled out as by-products during the reaction. The silica particle-containing polysiloxane solution (PS-1) obtained had a solid content of 24.3 wt %, and the polysiloxane and silica particles accounted for 15 wt % and 85 wt %, respectively, of the solid content. The resulting silica particle-containing polysiloxane (PS-1) was subjected to ¹H-NMR and ²⁹Si-NMR analyses and the results given below were obtained, showing that the silica particle-containing polysiloxane (PS-1) prepared above had a structural unit as represented by one of the above formulae (1) to (3) or a structural unit as represented by one of above formulae (4) to (6): Peaks corresponding to R¹ in general formulae (1) to (3):

¹H-NMR (C₃D₆O (d=ppm)): 0.5 to 0.6 (m, 2H)

¹H-NMR (C₃D₆O (d=ppm)): 1.7 to 1.8 (m, 2H)

Peaks corresponding to Si in general formula (1):

²⁹Si-NMR (C₃D₆O (d=ppm)): −63 to −72 (m, Si)

Peaks corresponding to Si in general formula (2):

²⁹Si-NMR (C₃D₆O (d=ppm)): −56 to −63 (m, Si)

Peaks corresponding to Si in general formula (3):

²⁹Si-NMR (C₃D₆O (d=ppm)): −51 to −54 (m, Si)

Peaks corresponding to (meth)acryloyl groups containing R⁴ and R⁵ in general formulae (4) to (6):

¹H-NMR (C₃D₆O (d=ppm)): 1.5 to 1.6 (m, 2H)

¹H-NMR (C₃D₆O (d=ppm)): 4.1 to 4.2 (m, 2H)

¹H-NMR (C₃D₆O (d=ppm)): 5.8 to 5.9 (m, H)

¹H-NMR (C₃D₆O (d=ppm)): 6.1 (m, H)

¹H-NMR (C₃D₆O (d=ppm)): 6.4 (m, H)

Peaks corresponding to Si in general formula (4):

²⁹Si-NMR (C₃D₆O (d=ppm)): −63 to −72 (m, Si)

Peaks corresponding to Si in general formula (5):

²⁹Si-NMR (C₃D₆O (d ppm)): −56 to −63 (m, Si)

Peaks corresponding to Si in general formula (6):

²⁹Si-NMR (C₃D₆O (d ppm)): −51 to −54 (m, Si)

### Synthesis Example 4

### silica Particle-Containing Polysiloxane Solution (PS-2)

In a 500 ml three-necked flask, 0.03 g (0.25 mmol) of methyltrimethoxysilane (KBM-13), 0.43 g (2.0 mmol) of trifluoropropyltrimethoxysilane (KBM-7103), 0.06 g (0.25 mmol) of trimethoxysilylpropylsuccinic anhydride (KBM-967), 5.19 g (22.5 mmol) of γ-acryloxypropyltrimethoxysilane (KBM-5103), and 232.02 g of an isopropyl alcohol dispersion containing 15.6 wt % of silica particles (IPA-ST-UP) were mixed, followed by adding 160.36 g of ethylene glycol mono-t-butyl ether. While stirring at room temperature, an aqueous phosphoric acid solution prepared by dissolving 0.057 g of phosphoric acid in 2.66 g of water was added over 3 minutes. Subsequently, the flask was immersed in an oil bath at 40° C., followed by stirring for 60 minutes and then heating the oil bath to reach 115° C. over 30 minutes. One hour after the start of heating, the internal temperature in the solution reached 100° C. and heating was continued further while stirring for additional 2 hours (the internal temperature maintained at 100° C. to 110° C.) to provide a silica particle-containing polysiloxane solution (PS-2). Here, nitrogen gas was supplied at a rate of 0.05 L (liter) per minute during the temperature elevation and heating/stirring periods. A total of 198.85 g of methanol and water was distilled out as by-products during the reaction. The silica particle-containing polysiloxane solution (PS-2) obtained had a solid content of 24.4 wt %, and the polysiloxane and silica particles accounted for 10 wt % and 90 wt %, respectively, of the solid content. The resulting silica particle-containing polysiloxane (PS-2) was subjected to ¹H-NMR and ²⁹Si-NMR analyses and the results given below were obtained, showing that the silica particle-containing polysiloxane (PS-2) prepared above had a structural unit as represented by one of the above formulae (1) to (3) or a structural unit as represented by one of above formulae (4) to (6): Peaks corresponding to R¹ in general formulae (1) to (3):

¹H-NMR (C₃D₆O (d=ppm)): 0.5 to 0.6 (m, 2H)

¹H-NMR (C₃D₆O (d=ppm)): 1.7 to 1.8 (m, 2H)

Peaks corresponding to Si in general formula (1):

²⁹Si-NMR (C₃D₆O (d ppm)): −63 to −72 (m, Si) Peaks corresponding to Si in general formula (2):

²⁹Si-NMR (C₃D₆O (d ppm)): −56 to −63 (m, Si) Peaks corresponding to Si in general formula (3):

²⁹Si-NMR (C₃D₆O (d ppm)): −51 to −54 (m, Si)

Peaks corresponding to (meth)acryloyl groups containing R⁴ and R⁵ in general formulae (4) to (6):

¹H-NMR (C₃D₆O (d=ppm)): 1.5 to 1.6 (m, 2H)

¹H-NMR (C₃D₆O (d=ppm)): 4.1 to 4.2 (m, 2H)

¹H-NMR (C₃D₆O (d=ppm)): 5.8 to 5.9 (m, H)

¹H-NMR (C₃D₆O (d=ppm)): 6.1 (m, H)

¹H-NMR (C₃D₆O (d=ppm)): 6.4 (m, H)

Peaks corresponding to Si in general formula (4):

²⁹Si-NMR (C₃D₆O (d ppm)): −63 to −72 (m, Si)

Peaks corresponding to Si in general formula (5):

²⁹Si-NMR (C₃D₆O (d ppm)): −56 to −63 (m, Si)

Peaks corresponding to Si in general formula (6):

²⁹Si-NMR (C₃D₆O (d ppm)): −51 to −54 (m, Si)

### Synthesis Example 5

### Silica Particle-Containing Polysiloxane Solution (PS-3)

In a 500 ml three-necked flask, 0.11 g (0.8 mmol) of methyltrimethoxysilane (KBM-13), 1.42 g (6.5 mmol) of trifluoropropyltrimethoxysilane (KBM-7103), 0.21 g (0.8 mmol) of trimethoxysilylpropylsuccinic anhydride (KBM-967), 17.16 g (73 mmol) of γ-acryloxypropyltrimethoxysilane (KBM-5103), and 199.05 g of an isopropyl alcohol dispersion containing 15.6 wt % of silica particles (IPA-ST-UP) were mixed, followed by adding 175.74 of ethylene glycol mono-t-butyl ether. While stirring at room temperature, an aqueous phosphoric acid solution prepared by dissolving 0.189 g of phosphoric acid in 8.82 g of water was added over 3 minutes. Subsequently, the flask was immersed in an oil bath at 40° C., followed by stirring for 60 minutes and then heating the oil bath to reach 115° C. over 30 minutes. One hour after the start of heating, the internal temperature in the solution reached 100° C. and heating was continued further while stirring for additional 2 hours (the internal temperature maintained at 100° C. to 110° C.) to provide a silica particle-containing polysiloxane solution (PS-3). Here, nitrogen gas was supplied at a rate of 0.05 L (liter) per minute during the temperature elevation and heating/stirring periods. A total of 178 g of methanol and water was distilled out as by-products during the reaction. The silica particle-containing polysiloxane solution (PS-3) obtained had a solid content of 24.2 wt %, and the polysiloxane and silica particles accounted for 30 wt % and 70 wt %, respectively, of the solid content. The resulting silica particle-containing polysiloxane (PS-3) was subjected to ¹H-NMR and ²⁹Si-NMR analyses and the results given below were obtained, showing that the silica particle-containing polysiloxane (PS-3) prepared above had a structural unit as represented by one of the above formulae (1) to (3) or a structural unit as represented by one of above formulae (4) to (6):

Peaks corresponding to R¹ in general formulae (1) to (3):

¹H-NMR (C₃D₆O (d=ppm)): 0.5 to 0.6 (m, 2H)

¹H-NMR (C₃D₆O (d=ppm)): 1.7 to 1.8 (m, 2H)

Peaks corresponding to Si in general formula (1):

²⁹Si-NMR (C₃D₆O (d ppm)): −63 to −72 (m, Si)

Peaks corresponding to Si in general formula (2):

²⁹Si-NMR (C₃D₆O (d ppm)): −56 to −63 (m, Si)

Peaks corresponding to Si in general formula (3):

²⁹Si-NMR (C₃D₆O (d ppm)): −51 to −54 (m, Si)

Peaks corresponding to (meth)acryloyl groups containing R⁴ and R⁵ in general formulae (4) to (6):

¹H-NMR (C₃D₆O (d=ppm)): 1.5 to 1.6 (m, 2H)

¹H-NMR (C₃D₆O (d=ppm)): 4.1 to 4.2 (m, 2H)

¹H-NMR (C₃D₆O (d=ppm)): 5.8 to 5.9 (m, H)

¹H-NMR (C₃D₆O (d=ppm)): 6.1 (m, H)

¹H-NMR (C₃D₆O (d=ppm)): 6.4 (m, H)

Peaks corresponding to Si in general formula (4):

²⁹Si-NMR (C₃D₆O (d ppm)): −63 to −72 (m, Si)

Peaks corresponding to Si in general formula (5):

²⁹Si-NMR (C₃D₆O (d ppm)): −56 to −63 (m, Si)

Peaks corresponding to Si in general formula (6):

²⁹Si-NMR (C₃D₆O (d ppm)): −51 to −54 (m, Si)

### Synthesis Example 6

### Silica Particle-Containing Polysiloxane Solution (PS-4)

In a 500 ml three-necked flask, 0.2 g (1.5 mmol) of methyltrimethoxysilane (KBM-13), 2.64 g (12.1 mmol) of trifluoropropyltrimethoxysilane (KBM-7103), 0.41 g (1.5 mmol) of trimethoxysilylpropylsuccinic anhydride (KBM-967), 31.89 g (136 mmol) of γ-acryloxypropyltrimethoxysilane (KBM-5103), and 158.5 g of an isopropyl alcohol dispersion containing 15.6 wt % of silica particles (IPA-ST-UP) were mixed, followed by adding 197.8 of ethylene glycol mono-t-butyl ether. While stirring at room temperature, an aqueous phosphoric acid solution prepared by dissolving 0.351 g of phosphoric acid in 16.38 g of water was added over 3 minutes. Subsequently, the flask was immersed in an oil bath at 40° C., followed by stirring for 60 minutes and then heating the oil bath to reach 115° C. over 30 minutes. One hour after the start of heating, the internal temperature in the solution reached 100° C. and heating was continued further while stirring for additional 2 hours (the internal temperature maintained at 100° C. to 110° C.) to provide a silica particle-containing polysiloxane solution (PS-3). Here, nitrogen gas was supplied at a rate of 0.05 L (liter) per minute during the temperature elevation and heating/stirring periods. A total of 153 g of methanol and water was distilled out as by-products during the reaction. The silica particle-containing polysiloxane solution (PS-4) obtained had a solid content of 24.4 wt %, and the polysiloxane and silica particles accounted for 50 wt % and 50 wt %, respectively, of the solid content. The resulting silica particle-containing polysiloxane (PS-4) was subjected to ¹H-NMR and ²⁹Si-NMR analyses and the results given below were obtained, showing that the silica particle-containing polysiloxane (PS-4) prepared above had a structural unit as represented by one of the above formulae (1) to (3) or a structural unit as represented by one of above formulae (4) to (6):

Peaks corresponding to R¹ in general formulae (1) to (3):

¹H-NMR (C₃D₆O (d=ppm)): 0.5 to 0.6 (m, 2H)

¹H-NMR (C₃D₆O (d=ppm)): 1.7 to 1.8 (m, 2H)

Peaks corresponding to Si in general formula (1):

²⁹Si-NMR (C₃D₆O (d ppm)): −63 to −72 (m, Si)

Peaks corresponding to Si in general formula (2):

²⁹Si-NMR (C₃D₆O (d ppm)): −56 to −63 (m, Si)

Peaks corresponding to Si in general formula (3):

²⁹Si-NMR (C₃D₆O (d ppm)): −51 to −54 (m, Si)

Peaks corresponding to (meth)acryloyl groups containing R⁴ and R⁵ in general formulae (4) to (6):

¹H-NMR (C₃D₆O (d=ppm)): 1.5 to 1.6 (m, 2H)

¹H-NMR (C₃D₆O (d=ppm)): 4.1 to 4.2 (m, 2H)

¹H-NMR (C₃D₆O (d=ppm)): 5.8 to 5.9 (m, H)

¹H-NMR (C₃D₆O (d=ppm)): 6.1 (m, H)

¹H-NMR (C₃D₆O (d=ppm)): 6.4 (m, H)

Peaks corresponding to Si in general formula (4):

²⁹Si-NMR (C₃D₆O (d ppm)): −63 to −72 (m, Si)

Peaks corresponding to Si in general formula (5):

²⁹Si-NMR (C₃D₆O (d ppm)): −56 to −63 (m, Si)

Peaks corresponding to Si in general formula (6):

²⁹Si-NMR (C₃D₆O (d ppm)): −51 to −54 (m, Si)

### Synthesis Example 7

### Silica Particle-Containing Polysiloxane Solution (PS-5)

In a 500 ml three-necked flask, 0.01 g (0.07 mmol) of methyltrimethoxysilane (KBM-13), 0.12 g (0.56 mmol) of trifluoropropyltrimethoxysilane (KBM-7103), 0.02 g (0.07 mmol) of trimethoxysilylpropylsuccinic anhydride (KBM-967), 1.5 g (6.3 mmol) of γ-acryloxypropyltrimethoxysilane (KBM-5103), and 242.16 g of an isopropyl alcohol dispersion containing 15.6 wt % of silica particles (IPA-ST-UP) were mixed, followed by adding 155.78 of ethylene glycol mono-t-butyl ether. While stirring at room temperature, an aqueous phosphoric acid solution prepared by dissolving 0.0166 g of phosphoric acid in 0.77 g of water was added over 3 minutes. Subsequently, the flask was immersed in an oil bath at 40° C., followed by stirring for 60 minutes and then heating the oil bath to reach 115° C. over 30 minutes. One hour after the start of heating, the internal temperature in the solution reached 100° C. and heating was continued further while stirring for additional 2 hours (the internal temperature maintained at 100° C. to 110° C.) to provide a silica particle-containing polysiloxane solution (PS-5). Here, nitrogen gas was supplied at a rate of 0.05 L (liter) per minute during the temperature elevation and heating/stirring periods. A total of 205 g of methanol and water was distilled out as by-products during the reaction. The silica particle-containing polysiloxane solution (PS-5) obtained had a solid content of 24.3 wt %, and the polysiloxane and silica particles accounted for 3 wt % and 97 wt %, respectively, of the solid content. The resulting silica particle-containing polysiloxane (PS-5) was subjected to ¹H-NMR and ²⁹Si-NMR analyses and the results given below were obtained, showing that the silica particle-containing polysiloxane (PS-5) prepared above had a structural unit as represented by one of the above formulae (1) to (3) or a structural unit as represented by one of above formulae (4) to (6):

Peaks corresponding to R¹ in general formulae (1) to (3):

¹H-NMR (C₃D₆O (d=ppm)): 0.5 to 0.6 (m, 2H)

¹H-NMR (C₃D₆O (d=ppm)): 1.7 to 1.8 (m, 2H)

Peaks corresponding to Si in general formula (1):

²⁹Si-NMR (C₃D₆O (d ppm)): −63 to −72 (m, Si)

Peaks corresponding to Si in general formula (2):

²⁹Si-NMR (C₃D₆O (d ppm)): −56 to −63 (m, Si)

Peaks corresponding to Si in general formula (3):

²⁹Si-NMR (C₃D₆O (d ppm)): −51 to −54 (m, Si)

Peaks corresponding to (meth)acryloyl groups containing R⁴ and R⁵ in general formulae (4) to (6):

¹H-NMR (C₃D₆O (d=ppm)): 1.5 to 1.6 (m, 2H)

¹H-NMR (C₃D₆O (d=ppm)): 4.1 to 4.2 (m, 2H)

¹H-NMR (C₃D₆O (d=ppm)): 5.8 to 5.9 (m, H)

¹H-NMR (C₃D₆O (d=ppm)): 6.1 (m, H)

¹H-NMR (C₃D₆O (d=ppm)): 6.4 (m, H)

Peaks corresponding to Si in general formula (4):

²⁹Si-NMR (C₃D₆O (d=ppm)): −63 to −72 (m, Si)

Peaks corresponding to Si in general formula (5):

²⁹Si-NMR (C₃D₆O (d=ppm)): −56 to −63 (m, Si)

Peaks corresponding to Si in general formula (6):

²⁹Si-NMR (C₃D₆O (d ppm)): −51 to −54 (m, Si)

TABLE 1

Weight ratio (%)

| | | | silica |
|---|---|---|---|
| | Name | polysiloxane | particles |
| Synthesis example 3 | PS-1 | 15 | 85 |
| Synthesis example 4 | PS-2 | 10 | 90 |
| Synthesis example 5 | PS-3 | 30 | 70 |
| Synthesis example 6 | PS-4 | 50 | 50 |
| Synthesis example 7 | PS-5 | 3 | 97 |

### Preparation Example 1

### Composition 1 for Forming Color Filter Containing Red Quantum Dots

First, 20 parts by weight of a toluene solution containing 0.5 wt % of a red quantum dot material (Lumidot 640 CdSe/ZnS, average particle size 6.3 nm, manufactured by Aldrich), 45 parts by weight of dipentaerythritol hexaacrylate (DPHA, manufactured by Shin-Nakamura Chemical Co., Ltd.), 5 parts by weight of Irgacure (registered trademark) 907 (manufactured by BASF), 166 parts by weight of a 30 wt % solution of an alkali-soluble resin (Adeka ARKLS WR-301, manufactured by Adeka Corporation) diluted with propylene glycol monomethyl ether acetate (PGMEA), and 97 parts by weight of toluene were mixed and stirred to ensure uniform dissolution. Filtration was performed through a 0.45 μm syringe filter to prepare Composition 1 for forming pixels containing red quantum dots.

### Preparation Example 2

### Composition 2 for Forming Pixels Containing Red Organic Phosphor

First, 0.1 part by weight of the red phosphor R-1 prepared in Synthesis 1, 45 parts by weight of dipentaerythritol hexaacrylate (DPHA), 5 parts by weight of Irgacure 907, 166 parts by weight of a PGMEA solution containing 30 wt % of an alkali-soluble resin (WR-301), and 117 parts by weight of toluene were mixed and stirred to ensure uniform dissolution. Filtration was performed through a 0.45 μm syringe filter to prepare Composition 2 for forming pixels containing a red organic phosphor.

### Preparation Example 3

### Composition for Forming Pixels Containing Green Quantum Dots

First, 80 parts by weight of a toluene solution containing 0.5 wt % of a green quantum dot material (Lumidot 530 CdSe/ZnS, average particle size 3.3 nm, manufactured by Aldrich), 45 parts by weight of dipentaerythritol hexaacrylate (DPHA), 5 parts by weight of Irgacure 907, 166 parts by weight of a PGMEA solution containing 30 wt % of an alkali-soluble resin (WR-301), and 38 parts by weight of toluene were mixed and stirred to ensure uniform dissolution. Filtration was performed through a 0.45 μm syringe filter to prepare Composition 3 for forming pixels containing green quantum dots.

### Preparation Example 4

### Composition 4 for Forming Pixels Containing Green Organic Phosphor

First, 0.4 part by weight of the green phosphor G-1 prepared in Synthesis example 2, 45 parts by weight of dipentaerythritol hexaacrylate (DPHA), 5 parts by weight of Irgacure 907, 166 parts by weight of a PGMEA solution containing 30 wt % of an alkali-soluble resin (WR-301), and 117 parts by weight of toluene were mixed and stirred to ensure uniform dissolution. Filtration was performed through a 0.45 μm syringe filter to prepare Composition 4 for forming pixels containing a green organic phosphor.

### Preparation Example 5

### Composition 5 of Resin for Light Diffusion Prevention

First, 54 g of the silica particle-containing polysiloxane solution (PS-1) prepared in Synthesis example 3, 12 g of ethylene glycol mono-t-butyl ether (ETB), and 35 g of diacetone alcohol (DAA) were mixed. Then, filtration was performed through a 0.45 μm syringe filter to prepare Composition 5 of resin for light diffusion prevention.

### Preparation Example 6

### Composition 6 of Resin for Light Diffusion Prevention

First, 54 g of the silica particle-containing polysiloxane solution (PS-2) prepared in Synthesis example 4, 12 g of ETB, and 35 g DAA were mixed. Then, filtration was performed through a 0.45 μm syringe filter to prepare a Composition 6 of a resin for light diffusion prevention.

### Preparation Example 7

### Composition 7 of Resin for Light Diffusion Prevention

First, 54 g of the silica particle-containing polysiloxane solution (PS-3) prepared in Synthesis example 5, 12 g of ETB, and 35 g DAA were mixed. Then, filtration was performed through a 0.45 μm syringe filter to prepare a Composition 7 of a resin for light diffusion prevention.

### Preparation Example 8

### Composition 8 of Polysiloxane Resin

First, 54 g of the silica particle-containing polysiloxane solution (PS-4) prepared in Synthesis example 6, 12 g of ETB, and 35 g DAA were mixed. Then, filtration was performed through a 0.45 μm syringe filter to prepare Composition 8 of polysiloxane resin.

### Preparation Example 9

### Polysiloxane Resin Composition 9

First, 54 g of the silica particle-containing polysiloxane solution (PS-5) prepared in Synthesis example 7, 12 g of ETB, and 35 g DAA were mixed. Then, filtration was performed through a 0.45 μm syringe filter to prepare Composition 9 of polysiloxane resin.

### Preparation Example 10

### Resin Composition 10

First, 45 parts by weight of dipentaerythritol hexaacrylate (DPHA), 5 parts by weight of Irgacure 907, 166 parts by weight of a PGMEA solution containing 30 wt % of an alkali-soluble resin (WR-301), and 117 parts by weight of PGMEA were mixed. Filtration was performed through a 0.45 μm syringe filter to prepare Resin composition 10.

The evaluation methods used in Examples and Comparative examples are described below.

### <Refractive Index>

To replace the light diffusion preventing layer in each Example and Comparative example, a cured film was produced by the following procedure and the refractive index at a wavelength of 550 nm was measured at 23° C. using a prism coupler (PC-2000, manufactured by Metricon, which is a refractive index measuring device.

On a silicon wafer, the composition of resin for light diffusion prevention used to prepare a light diffusion preventing layer in each Example was applied by a spinner, dried in a hot air oven at 100° C. for 5 minutes, and further heated in the hot air oven at 150° C. for 30 minutes to provide a cured film that has the same quality as the light diffusion preventing layer.

On a silicon wafer, Composition 8 of polysiloxane resin used in Comparative example 3 was applied by a spinner and dried in a hot air oven at 100° C. for 10 minutes. Then, a parallel light mask aligner (PLA-501F, manufactured by Canon Inc.) was used with an ultrahigh pressure mercury lamp as light source to apply light to an exposure of 200 mJ/cm² (i-line). Subsequently, using an automatic development apparatus (AD-2000, manufactured by Takizawa Sangyo Co., Ltd.), shower development was performed for 60 seconds with a 2.38 wt % aqueous solution of tetramethyl ammonium hydroxide, followed by rinsing with water for 30 seconds. Furthermore, heat treatment was performed in a hot air oven at 150° C. for 30 minutes to provide a cured film of the polysiloxane resin composition.

### <Transmittance>

The transmittance of a substrate used in each Example and Comparative example was measured using an ultraviolet-visible spectrophotometer (UV-260, manufactured by Shimadzu Corporation) in the wavelength range of 400 to 800 nm.

As for the light diffusion preventing layers, cured films produced by the following procedure were used for measurement instead of the light diffusion preventing layers prepared in each Example and Comparative example.

Using a spin coater, the composition of resin for light diffusion prevention used to form a light diffusion preventing layer in each Example was applied on a 5 cm×5 cm glass transparent base (manufactured by AGC Techno Glass Co., Ltd., thickness 0.5 mm) by spin coating, followed by prebaking at 90° C. for 2 minutes on a hot plate to produce a prebaked film with a thickness of 2.1 μm. Subsequently, curing was performed in air at 150° C. for 1 hour using an oven (IHPS-222, manufactured by Espec Corp.) to produce a cured film having a thickness of 2.0 μm. The substrate obtained was subjected to transmittance measurement in the range of 400 to 800 nm using an ultraviolet-visible spectrophotometer (UV-260 (trade name), manufactured by Shimadzu Corporation).

For background measurement, the transmittance of the glass transparent base alone was determined and the transmittance of the light diffusion preventing layer was calculated by subtracting the transmittance of the glass transparent base from the transmittance of the combination of the glass transparent base and the light diffusion preventing layer formed thereon.

### <Pixel Film Thickness and Pixel Size>

The pixel film thickness in each example and comparative example was determined by measuring the height of the step on the color filter substrate having a pixel pattern formed thereon by using a Surfcom stylus type film thickness measuring device. To measure the pixel size, the pixel pattern on a color filter substrate having a pixel pattern formed thereon was observed under an optical microscope (Olympus LG-PS2) at a magnification of 100 times.

<Thickness of Light Diffusion Preventing Layer>To determine the thickness of the light diffusion preventing layer prepared in each Example, the total thickness of the pixel layer and the light diffusion preventing layer in the color filter substrate containing the light diffusion preventing layer was measured using a Surfcom stylus type film thickness measuring device, and the thickness of the pixel layer measured by the procedure described above was subtracted.

### <Luminance>

The substrate prepared in each Example and Comparative example was placed on an LED package (HLV2-22, manufactured by CCS Inc.) having an emission wavelength region of 410 to 480 nm and an emission wavelength peak of 460 nm. A current of 30 mA was supplied to the LED package to turn on the LED and the luminance at the maximum emission wavelengths was measured using a spectral radiance meter (CS-1000, manufactured by Konica Minolta, Inc.). The distance between the substrate and the LED package was 3 cm.

### Example 1

Composition 1 for forming pixels containing red quantum dots prepared in Preparation example 1 was applied by a spinner on a 5 cm x 5 cm glass transparent base (manufactured by AGC Techno Glass Co., Ltd., thickness 0.5 mm, transmittance 95% (400 nm), 95% (550 nm), 95% (633 nm), and 95% (800 nm)), and then dried in a hot air oven at 100° C. for 10 minutes. Then, a parallel light mask aligner (PLA-501F, manufactured by Canon Inc.) was used with an ultrahigh pressure mercury lamp as light source to apply light through a photomask to an exposure of 200 mJ/cm² (i-line). After performing shower development for 60 seconds with an aqueous tetramethyl ammonium hydroxide solution, washing with pure water was performed to provide a patterned substrate. The resulting patterned substrate was heated in a hot air oven at 150° C. for 30 minutes to form a rectangular red pixel pattern having a short side of 30 μm and a long side of 150 μm on the glass transparent base.

Then, except that Composition 3 for forming pixels containing green quantum dots prepared in Preparation example 3 was used instead of Composition 1 for forming pixels containing red quantum dots, the same procedure as that for forming red pixels was carried out to form a rectangular green pixel pattern having a short side of 30 μm and a long side of 150 μm on a glass transparent base.

On the substrate having the red pixel pattern and the green pixel pattern formed thereon, Composition 5 of resin for light diffusion prevention prepared in Preparation example 5 was applied by a spinner, dried in a hot air oven at 100° C. for 5 minutes, and further heated in a hot air oven at 150° C. for 30 minutes to form a light diffusion preventing layer, thereby providing a substrate having a structure as shown in FIG. 6. The luminance was measured by the method described above, and results showed that the emission peak wavelengths were 530 nm and 640 nm, and the luminance was 3,320 cd/m². The transmittance of the light diffusion preventing layer was measured by the method described above, and results showed that the transmittance at 400 nm was 99%; the transmittance at 550 nm was 99%; the transmittance at 633 nm was 99%; and the transmittance at 800 nm was 99%.

### Example 2

Composition 2 for forming pixels containing red organic phosphor prepared in Preparation example 2 was applied by a spinner on a 5 cm×5 cm glass transparent base (manufactured by AGC Techno Glass Co., Ltd., thickness 0.5 mm, transmittance 95% (400 nm), 95% (550 nm), 95% (633 nm), and 95% (800 nm)), and then dried in a hot air oven at 100° C. for 10 minutes. Then, a parallel light mask aligner (PLA-501F, manufactured by Canon Inc.) was used with an ultrahigh pressure mercury lamp as light source to apply light through a photomask to an exposure of 200 mJ/cm² (i-line). After performing shower development for 60 seconds with an aqueous tetramethyl ammonium hydroxide solution, washing with pure water was performed to provide a patterned substrate. The resulting patterned substrate was heat-treated in a hot air oven at 150° C. for 30 minutes to form a rectangular red pixel pattern having a short side of 30 μm and a long side of 150 μm on the glass transparent base.

Then, except that Composition 4 for forming pixels containing green organic phosphor prepared in Preparation example 4 was used instead of Composition 2 for forming pixels containing red organic phosphor, the same procedure as that for forming red pixels was carried out to form a rectangular green pixel pattern having a short side of 30 μm and a long side of 150 μm on the glass transparent base.

Except that Composition 5 of resin for light diffusion prevention prepared in Preparation example 5 was applied on the substrate having the red pixel pattern and the green pixel pattern formed thereon, the same procedure as in Example 1 was carried out to form a light diffusion preventing layer, thereby providing a substrate having a structure as shown in FIG. 7. The luminance was measured by the method described above, and results showed that the emission peak wavelengths were 526 nm and 640 nm, and the luminance was 2,770 cd/m².

### Examples 3 and 4

Except that the thicknesses of the red pixel and green pixel layers were changed as described in Table 1, the same procedure as in Example 1 was carried out to form a substrate. Evaluation results are given in Table 2.

### Example 5

Except that Composition 6 of resin for light diffusion prevention prepared in Preparation example 6 was used instead of Composition 5 of resin for light diffusion prevention, the same procedure as in Example 1 was carried out to form a substrate. The transmittance of the light diffusion preventing layer was measured, and results showed that the transmittance at 400 nm was 99%; the transmittance at 550 nm was 99%; the transmittance at 633 nm was 99%; and the transmittance at 800 nm was 99%. Evaluation results are given in Table 2.

### Example 6

Except that Composition 7 of resin for light diffusion prevention prepared in Preparation example 7 was used instead of Composition 5 of resin for light diffusion prevention, the same procedure as in Example 1 was carried out to form a substrate. The transmittance of the light diffusion preventing layer was measured, and results showed that the transmittance at 400 nm was 98%; the transmittance at 550 nm was 99%; the transmittance at 633 nm was 99%; and the transmittance at 800 nm was 99%. Evaluation results are given in Table 2.

### Example 7

A silicon nitride film having a thickness of 4 μm was formed using a plasma CVD apparatus (PD-220NL, manufactured by Samco Inc.) on a 5 cm×5 cm glass transparent base (manufactured by AGC Techno Glass Co., Ltd., thickness 0.5 mm, transmittance 95% (400 nm), 95% (550 nm), 95% (633 nm), and 95% (800 nm)). The refractive index of the nitride silicon film was 1.9. A positive type photoresist (AZ-601, manufactured by AZ Electronic Materials) was applied on the silicon nitride film, followed by light exposure and development to form a resist pattern 11 having a line width of 5 μm and a film thickness of 2 μm as shown in FIG. 8. Using a dry etching device (RIE-200iP, manufactured by Samco Inc.), the silicon nitride film was etched to form a division wall 7 of silicon nitride as shown in FIG. 9.

On the substrate having the division wall formed thereon, a red pixel layer, a green pixel layer, and a light diffusion preventing layer were formed by the same procedure as in Example 1 to provide a substrate having a structure as shown in FIG. 10. Evaluation results are given in Table 2.

### Example 8

A red pixel pattern and a green pixel pattern were formed on a glass transparent base by the same procedure as in Example 1, followed by forming a silicon nitride film having a film thickness of 500 nm by a plasma CVD device (PD-220NL, manufactured by Samco Inc.) to produce a protective layer I. On the protective layer I, a light diffusion preventing layer was formed by the same procedure as in Example 1 to produce a substrate having a structure as shown in FIG. 11. Evaluation results are given in Table 2.

### Example 9

Except that the protective layer I had a thickness of 2,000 nm, the same procedure as in Example 8 was carried out to produce a substrate. Evaluation results are given in Table 2.

### Example 10

A light diffusion preventing layer was formed on a glass transparent base having a red pixel pattern and a green pixel pattern formed thereon by the same procedure as in Example 1 and then a protective layer II of silicon nitride having a thickness of 500 nm was formed by a plasma CVD device (PD-220NL, manufactured by Samco Inc.) to produce a substrate having a structure as shown in FIG. 12. Evaluation results are given in Table 2.

### Example 11

Except that the protective layer II had a thickness of 2,000 nm, the same procedure as in Example 10 was carried out to produce a substrate. Evaluation results are given in Table 2.

### Example 12

A red pixel pattern and a green pixel pattern were formed on a glass transparent base by the same procedure as in Example 1, followed by forming a silicon nitride film having a film thickness of 500 nm by a plasma CVD device (PD-220NL, manufactured by Samco Inc.) to produce a protective layer I. On the protective layer I, a light diffusion preventing layer was formed by the same procedure as in Example 1 to provide a substrate having a structure as shown in FIG. 10. In addition, a protective layer II of silicon nitride having a thickness of 500 nm was formed by a plasma CVD device (PD-220NL, manufactured by Samco Inc.) to produce a substrate having a structure as shown in FIG. 4.

### Example 13

Composition 5 of resin for light diffusion prevention prepared in Preparation example 5 was applied by a spinner on a 5 cm×5 cm glass transparent base (manufactured by AGC Techno Glass Co., Ltd., thickness 0.5 mm, transmittance 95% (400 nm), 95% (550 nm), 95% (633 nm), and 95% (800 nm)), dried in a hot air oven at 100° C. for 5 minutes, and further heated in a hot air oven at 150° C. for 30 minutes to produce a refractive index adjusting layer. In addition, Composition 1 for forming pixels containing red quantum dots prepared in Preparation example 1 was applied by a spinner on the refractive index adjusting layer, followed by heating it in a hot air oven at 100° C. for 10 minutes. Then, a parallel light mask aligner (PLA-501F, manufactured by Canon Inc.) was used with an ultrahigh pressure mercury lamp as light source to apply light through a photomask to an exposure of 200 mJ/cm² (i-line). After performing shower development for 60 seconds with an aqueous tetramethyl ammonium hydroxide solution, washing with pure water was performed to provide a patterned substrate. The resulting patterned substrate was heated in a hot air oven at 150° C. for 30 minutes to form a rectangular red pixel pattern having a short side of 30 μm and a long side of 150 μm on the glass transparent base.

Then, except that Composition 3 for forming pixels containing green quantum dots prepared in Preparation example 3 was used instead of Composition 1 for forming pixels containing red quantum dots, the same procedure as that for forming red pixels was carried out to form a rectangular green pixel pattern having a short side of 30 μm and a long side of 150 μm on a glass transparent base.

On the substrate having the red pixel pattern and the green pixel pattern formed thereon, Composition 5 of resin for light diffusion prevention prepared in Preparation example 5 was applied by a spinner, dried in a hot air oven at 100° C. for 5 minutes, and further heated in a hot air oven at 150° C. for 30 minutes to form a light diffusion preventing layer, thereby providing a substrate having a structure as shown in FIG. 5. The luminance was measured by the method described above, and results showed that the emission peak wavelengths were 530 nm and 640 nm, and the luminance was 3,548 cd/m². The transmittance of the light diffusion preventing layer was measured by the method described above, and results showed that the transmittance at 400 nm was 99%; the transmittance at 550 nm was 99%; the transmittance at 633 nm was 99%; and the transmittance at 800 nm was 99%.

### Example 14

Composition 7 of resin for light diffusion prevention prepared in Preparation example 7 was applied by a spinner on a 5 cm×5 cm glass transparent base (manufactured by AGC Techno Glass Co., Ltd., thickness 0.5 mm, transmittance 95% (400 nm), 95% (550 nm), 95% (633 nm), and 95% (800 nm)), dried in a hot air oven at 100° C. for 5 minutes, and further heated in a hot air oven at 150° C. for 30 minutes to produce a refractive index adjusting layer. In addition, Composition 1 for forming pixels containing red quantum dots prepared in Preparation example 1 was applied by a spinner on the refractive index adjusting layer, followed by heating it in a hot air oven at 100° C. for 10 minutes. Then, a parallel light mask aligner (PLA-501F, manufactured by Canon Inc.) was used with an ultrahigh pressure mercury lamp as light source to apply light through a photomask to an exposure of 200 mJ/cm² (i-line). After performing shower development for 60 seconds with an aqueous tetramethyl ammonium hydroxide solution, washing with pure water was performed to provide a patterned substrate. The resulting patterned substrate was heated in a hot air oven at 150° C. for 30 minutes to form a rectangular red pixel pattern having a short side of 30 μm and a long side of 150 μm on the glass transparent base.

Then, except that Composition 3 for forming pixels containing green quantum dots prepared in Preparation example 3 was used instead of Composition 1 for forming pixels containing red quantum dots, the same procedure as that for forming red pixels was carried out to form a rectangular green pixel pattern having a short side of 30 μm and a long side of 150 μm on a glass transparent base.

On the substrate having the red pixel pattern and the green pixel pattern formed thereon, Composition 5 of resin for light diffusion prevention prepared in Preparation example 5 was applied by a spinner, dried in a hot air oven at 100° C. for 5 minutes, and further heated in a hot air oven at 150° C. for 30 minutes to form a light diffusion preventing layer, thereby providing a substrate having a structure as shown in FIG. 5. The luminance was measured by the method described above, and results showed that the emission peak wavelengths were 530 nm and 640 nm, and the luminance was 3,326 cd/m². The transmittance of the light diffusion preventing layer was measured by the method described above, and results showed that the transmittance at 400 nm was 99%; the transmittance at 550 nm was 99%; the transmittance at 633 nm was 99%; and the transmittance at 800 nm was 99%.

### Comparative Example 1

Except for omitting the formation of a light diffusion preventing layer, the same procedure as in Example 1 was carried out to provide a substrate having a structure as shown in FIG. 13. The luminance was measured and results showed that the emission wavelength peaks were at 530 nm and 640 nm, and the luminance was 2,560 cd/m².

### Comparative Example 2

Except for omitting the formation of a light diffusion preventing layer, the same procedure as in Example 2 was carried out to provide a substrate having a structure as shown in FIG. 14. The luminance was measured and results showed that the emission wavelength peaks were at 526 nm and 640 nm, and the luminance was 2,131 cd/m². Results are shown in Table 2.

### Comparative Example 3

Except that Composition 8 of polysiloxane resin prepared in Preparation example 8 was used instead of Composition 5 of resin for light diffusion prevention, the same procedure as in Example 1 was carried out to form a substrate. The transmittance of the light diffusion preventing layer was measured, and results showed that the transmittance at 400 nm was 98%; the transmittance at 550 nm was 99%; the transmittance at 633 nm was 99%; and the transmittance at 800 nm was 99%. Its refractive index was 1.42, which is outside the refractive index range of the light diffusion preventing layer according to the present invention. Evaluation results are given in Table 2.

### Comparative Example 4

Except that Composition 9 of polysiloxane resin prepared in Preparation example 9 was used instead of Composition 5 of resin for light diffusion prevention, the same procedure as in Example 1 was carried out to form a substrate, but it was not evaluable because of cracks found over the entire surface of the light diffusion preventing layer. It is considered that the film suffered from a large stress because the silica particles in the light diffusion preventing layer failed to meet the requirements of the present invention.

### Comparative Example 5

A red pixel pattern and a green pixel pattern were formed on a glass transparent base by the same procedure as in Example 1, and then the resin composition 10 prepared in Preparation example 10 was applied by a spinner and dried in a hot air oven at 100° C. for 5 minutes. Then, a parallel light mask aligner (PLA-501F, manufactured by Canon Inc.) was used with an ultrahigh pressure mercury lamp as light source to apply light to an exposure of 200 mJ/cm² (i-line). Using an automatic development apparatus (AD-2000, manufactured by Takizawa Sangyo Co., Ltd.), shower development was performed for 60 seconds with a 2.38 wt % aqueous solution of tetramethyl ammonium hydroxide, followed by rinsing with water for 30 seconds. Furthermore, heating was performed in a hot air oven at 150° C. for 30 minutes to produce a substrate having a cured film of Composition 10 of polysiloxane resin. The luminance was measured by the method described above, and results showed that the emission wavelength peaks were at 530 nm and 640 nm, and the luminance was 2,048 cd/m². The transmittance of the light diffusion preventing layer was measured, and results showed that the transmittance at 400 nm was 97%; the transmittance at 550 nm was 99%; the transmittance at 633 nm was 99%; and the transmittance at 800 nm was 99%. It has a refractive index of 1.54 and fails to contain siloxane and silica, showing that it does not meet the requirement for the light diffusion preventing layer according to the present invention.

### Comparative Example 6

Composition 5 of resin for light diffusion prevention prepared in Preparation example 5 was applied by a spinner on a 5 cm×5 cm glass transparent base (manufactured by AGC Techno Glass Co., Ltd., thickness 0.5 mm, transmittance 95% (400 nm), 95% (550 nm), 95% (633 nm), and 95% (800 nm)), dried in a hot air oven at 100° C. for 5 minutes, and further heated in a hot air oven at 150° C. for 30 minutes to produce a refractive index adjusting layer. In addition, the composition 1 for forming pixels containing red quantum dots prepared in Preparation example 1 was applied by a spinner on the refractive index adjusting layer, followed by heating it in a hot air oven at 100° C. for 10 minutes. Then, a parallel light mask aligner (PLA-501F, manufactured by Canon Inc.) was used with an ultrahigh pressure mercury lamp as light source to apply light through a photomask to an exposure of 200 mJ/cm² (i-line). After performing shower development for 60 seconds with an aqueous tetramethyl ammonium hydroxide solution, washing with pure water was performed to provide a patterned substrate. The resulting patterned substrate was heated in a hot air oven at 150° C. for 30 minutes to form a rectangular red pixel pattern having a short side of 30 μm and a long side of 150 μm on the glass transparent base.

Then, except that Composition 3 for forming pixels containing green quantum dots prepared in Preparation example 3 was used instead of Composition 1 for forming pixels containing red quantum dots, the same procedure as that for forming red pixels was carried out to form a rectangular green pixel pattern having a short side of 30 μm and a long side of 150 μm on a glass transparent base. The luminance of the resulting substrate was measured and results showed that the emission peak wavelengths were at 530 nm and 640 nm, and the luminance was 2,710 cd/m².

TABLE 2

| | Color conversion light emitting layer | | | | | | |
|---|---|---|---|---|---|---|---|
| | Red pixel | | Green pixel | | Light diffusion preventing layer | | |
| | | thickness | | thickness | | thickness | refractive |
| | composition | (μm) | green pixel | (μm) | composition | (μm) | index |
| Example 1 | composition 1 | 8 | composition 3 | 8 | composition 5 | 4 | 1.25 |
| Example 2 | composition 2 | 8 | composition 4 | 8 | composition 5 | 4 | 1.25 |
| Example 3 | composition 1 | 4 | composition 3 | 4 | composition 5 | 4 | 1.25 |
| Example 4 | composition 1 | 12 | composition 3 | 12 | composition 5 | 4 | 1.25 |
| Example 5 | composition 1 | 8 | composition 3 | 8 | composition 6 | 4 | 1.22 |
| Example 6 | composition 1 | 8 | composition 3 | 8 | composition 7 | 4 | 1.33 |
| Example 7 | composition 1 | 8 | composition 3 | 8 | composition 5 | 4 | 1.25 |
| Example 8 | composition 1 | 8 | composition 3 | 8 | composition 5 | 4 | 1.25 |
| Example 9 | composition 1 | 8 | composition 3 | 8 | composition 5 | 4 | 1.25 |
| Example 10 | composition 1 | 8 | composition 3 | 8 | composition 5 | 4 | 1.25 |
| Example 11 | composition 1 | 8 | composition 3 | 8 | composition 5 | 4 | 1.25 |
| Example 12 | composition 1 | 8 | composition 3 | 8 | composition 5 | 4 | 1.25 |
| Example 13 | composition 1 | 8 | composition 3 | 8 | composition 5 | 4 | 1.25 |
| Example 14 | composition 1 | 8 | composition 3 | 8 | composition 5 | 4 | 1.25 |
| Comparative | composition 1 | 8 | composition 3 | 8 | — | — | — |
| example 1 | | | | | | | |
| Comparative | composition 2 | 8 | composition 4 | 8 | — | — | — |
| example 2 | | | | | | | |
| Comparative | composition 1 | 8 | composition 4 | 8 | composition 8* | 4 | 1.42* |
| example 3 | | | | | | | |
| Comparative | composition 1 | 8 | composition 4 | 8 | composition 9* | — | — |
| example 4 | | | | | | | |
| Comparative | composition 1 | 8 | composition 3 | 8 | composition 10* | 4 | 1.54* |
| example 5 | | | | | | | |
| Comparative | composition 1 | 8 | composition 3 | 8 | — | — | — |
| example 6 | | | | | | | |

| | | | | Refractive index | | |
|---|---|---|---|---|---|---|
| | | Protective | | adjusting layer | | |
| | Division | layer | | present/ | refractive | Luminance |
| | wall | (I) | (II) | absent | index | cd/m² |
| Example 1 | — | — | — | absent | — | 3,320 |
| Example 2 | — | — | — | absent | — | 2,770 |
| Example 3 | — | — | — | absent | — | 3,818 |
| Example 4 | — | — | — | absent | — | 2,822 |
| Example 5 | — | — | — | absent | — | 3,287 |
| Example 6 | — | — | — | absent | — | 3,056 |
| Example 7 | present | — | — | absent | — | 3,652 |
| Example 8 | — | present | — | absent | — | 3,210 |
| Example 9 | — | present | — | absent | — | 2,984 |
| Example 10 | — | — | present | absent | — | 3,380 |
| Example 11 | — | — | present | absent | — | 3,187 |
| Example 12 | — | present | present | absent | — | 3,433 |
| Example 13 | — | — | — | present | 1.25 | 3,548 |
| Example 14 | — | — | — | present | 1.33 | 3,326 |
| Comparative | — | — | — | absent | — | 2,560 |
| example 1 | | | | | | |
| Comparative | — | — | — | absent | — | 2,131 |
| example 2 | | | | | | |
| Comparative | — | — | — | absent | — | 2,265 |
| example 3 | | | | | | |
| Comparative | — | — | — | absent | — | — |
| example 4 | | | | | | |
| Comparative | — | — | — | absent | — | 2,048 |
| example 5 | | | | | | |
| Comparative | — | — | — | present | 1.25 | 2,710 |
| example 6 | | | | | | |

*not meeting the requirement for light diffusion preventing layer of the present invention

### EXPLANATION OF NUMERALS

1: transparent base

2: light diffusion preventing layer

3: color conversion light emitting layer containing red quantum dots

4: color conversion light emitting layer containing green quantum dots

5: color conversion light emitting layer containing red organic phosphor

6: color conversion light emitting layer containing green organic phosphor

7: division wall

8: protective layer I

9: protective layer II

10: liquid crystal/backlight unit 10

11: resist pattern

12: refractive index adjusting layer

1. A substrate comprising a transparent base in combination with a color conversion light emitting layer, referred to as (a), and a light diffusion preventing layer, referred to as (b), disposed in this order on the transparent base, the light diffusion preventing layer (b) containing polysiloxane and chain silica particles, and the content of the polysiloxane and the content of the chain silica particles in the light diffusion preventing layer (b) being 4 to 32 wt % and 68 to 96 wt %, respectively.

2. A substrate as set forth in claim 1, wherein the light diffusion preventing layer (b) has a refractive index at a wavelength of 550 nm of 1.20 to 1.35.

3. A substrate comprising a transparent base in combination with a color conversion light emitting layer, referred to as (a), and a light diffusion preventing layer, referred to as (b), disposed in this order on the transparent base, the light diffusion preventing layer (b) having a refractive index at a wavelength of 550 nm of 1.20 to 1.35, the light diffusion preventing layer (b) containing polysiloxane and silica particles free of hollow structures, and the content of polysiloxane and the content of the silica particles free of hollow structures in the light diffusion preventing layer (b) being 4 to 32 wt % and 68 to 96 wt %, respectively.

4. A substrate as set forth in claim 1, wherein the polysiloxane in the light diffusion preventing layer (b) has a structure as represented by one of the general formulae (1) to (3) given below: 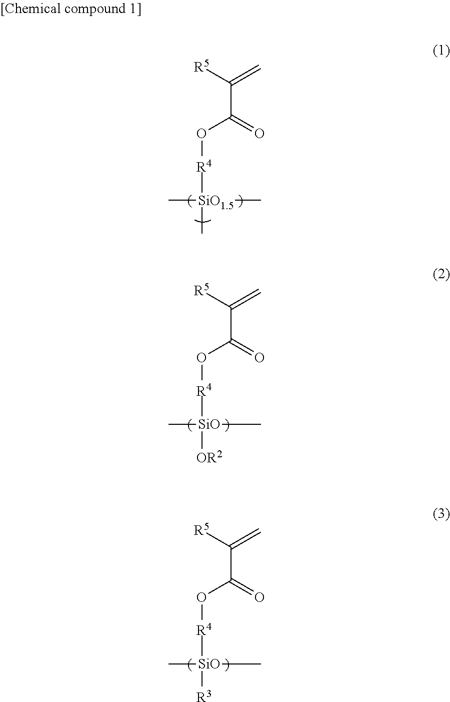
wherein, in the above general formulae (1) to (3), R² represents a monovalent hydrocarbon group having 1 to 3 carbon atoms; R³ represents an alkyl fluoride group having 1 to 10 carbon atoms or a monovalent hydrocarbon group having 1 to 3 carbon atoms; R⁴ represents a divalent hydrocarbon group having 1 to 10 carbon atoms; and R⁵ represents a hydrogen atom or a methyl group.

5. A substrate as set forth in claim 1, wherein the polysiloxane in the light diffusion preventing layer (b) has a structure as represented by one of the general formulae (4) to (6) given below: 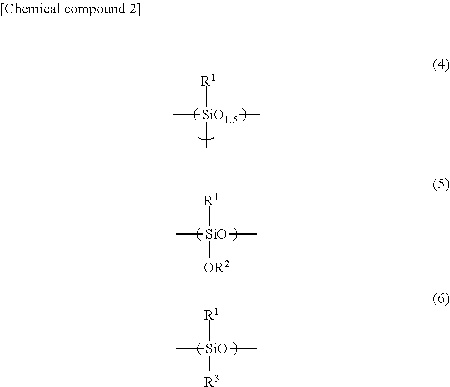
wherein, in the above general formulae (4) to (6), R¹ represents an alkyl fluoride group having 1 to 10 carbon atoms; R² represents a monovalent hydrocarbon group having 1 to 3 carbon atoms; and R³ represents an alkyl fluoride group having 1 to 10 carbon atoms or a monovalent hydrocarbon group having 1 to 3 carbon atoms.

6. A substrate as set forth in claim 1, wherein the color conversion light emitting layer (a) contains an inorganic phosphor and/or an organic phosphor.

7. A substrate as set forth in claim 6, wherein the inorganic phosphor contains quantum dots having an average particle diameter of 1 to 10 nm.

8. A substrate as set forth in claim 1, wherein color conversion light emitting layers (a) are disposed so that they are separated from each other by division walls.

9. A substrate as set forth in claim 1, wherein a protective layer I, referred to as (c), comprising an inorganic film having a thickness of 50 to 1,000 nm is disposed between the color conversion light emitting layer (a) and the light diffusion preventing layer (b).

10. A substrate as set forth in claim 1, wherein a protective layer II, referred to as (d), comprising an inorganic film having a thickness of 50 to 1,000 nm is disposed on the light diffusion preventing layer (b).

11. A substrate as set forth in claim 9, wherein the protective layer I (c) and/or the protective layer II (d) contains silicon nitride and/or silicon oxide.

12. A substrate as set forth in claim 1, further comprising a refractive index adjusting layer on the transparent base sheet.

13. A composition of resin for light diffusion prevention designed for forming a layer containing polysiloxane, silica particles free of hollow structures, and a solvent, the content of polysiloxane in the solid content being 4 to 32 wt %, that of silica particles free of hollow structures being 68 to 96 wt %, and the refractive index at a wavelength of 550 nm being 1.20 to 1.35.

14. An image display device comprising a substrate as set forth in claim 1, a TFT, and a backlight unit.
